(19) United States
(12) Patent Application Publication
(10) Pub. No.: US 2008/0158912 A1
(43) Pub. Date: Jul. 3, 2008

(54) LIGHT GUIDE PLATE

(75) Inventors: Yem-Yeu Chang, Chiayi County (TW); Wen-Hsun Yang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/743,159

(22) Filed: May 2, 2007

(30) Foreign Application Priority Data
Dec. 29, 2006 (TW) 95149990

(51) Int. Cl. F21V 7/04

(52) U.S. Cl. 362/628

(57) ABSTRACT

A light guide plate with a light emitting surface, a bottom surface and at least one light incident surface being connected with the light emitting surface and the bottom surface is provided. The light guide plate is a superposition of a plurality of layers substantially parallel to the light emitting surface. A plurality of stripe-shaped light-controlling structures are formed on the light emitting surface and a plurality of light-reflecting structures are formed on the bottom surface. The light guide plate provides a surface light source with high brightness and excellent uniformity in a direction perpendicular to the light emitting surface.

### CROSS-REFERENCE TO RELATED APPLICATION

This application claims the priority benefit of Taiwan application serial no. 95149990, filed Dec. 12, 2006. All disclosure of the Taiwan application is incorporated herein by reference.

### BACKGROUND OF THE INVENTION

1. Field of the Invention

The invention relates to a light guide plate composed of a plurality of material layers.

2. Description of Related Art

Because liquid crystal display panels pertain to non-self-lighting display panels, backlight modules are required to provide planar light sources. Side-type backlight modules utilize light guide plates to form the planar light sources. The light guide plate serves to redirect light entering through an incident side of the light guide plate from point light sources or a linear light source to be emitted through a light emitting surface of the light guide plate so as to form a planar light source. FIG. 1 is a schematic view of a conventional side-type backlight module. Referring to FIG. 1, in addition to a light source 110, a light guide plate 120 and a reflecting sheet 130, the conventional side-type backlight module 100 also has four optical films which are two diffusion sheets 140 and two prism sheets 150 perpendicular to each other. The prism sheets 150 serve to re-control the light field by limiting divergence angles of transmission light to increase brightness in the normal viewing direction. The prism sheet 150 can also be referred as brightness enhancement film (BEF). The diffusion sheets 140 function to diffuse light, which would increase the uniformity of brightness and cover the visual blemish (mura).

Light-dispersing micro-structures are initially applied on a light guide plate by means of pattern printing. Recently, wedge type light guide plates with mirror micro-structures (having surface roughness less than 0.01 μm) form by injection molding is provided to improve light utility ratio and to decrease the thickness and the weight of the light guide plate. Therefore, a light guide plate 120 having thinner thickness (0.6 mm˜3mm) can be obtained. However, the conventional backlight module 100 needs to utilize a plurality of optical films, and cost of these films is 30%˜40% of that of the whole backlight module 100, which results in high cost of the backlight module 100.

### SUMMARY OF THE INVENTION

The invention provides a light guide plate which has excellent light convergency and can provide a planar light source with excellent uniformity.

A light guide plate according to the invention has a light emitting surface, a bottom surface and at least one light incident surface connected with the light emitting surface and the bottom surface. The light guide plate is a superposition of a plurality of layers, which are transparent materials with different refractive indexes, substantially parallel to the light emitting surface. A plurality of stripe-shaped light-controlling structures are formed on the light emitting surface and a plurality of light-reflecting structures are formed on the bottom surface.

As mentioned above, in the invention, because a light guide plate formed with a plurality of layers is utilized, the convergency of emitted light is elevated. At the same time, the light path can be well-controlled by the light-controlling structures of the light emitting surface and the light-reflecting structures of the bottom surface so as to limit the light emitting angle and to uniform the illumination. Therefore, prism sheets and diffusion sheets would be eliminated from a backlight module when the light guide plate is utilized, so that the overall cost of the backlight module is reduced.

These and other objects will become more apparent from following description of embodiment, and in conjunction with appended drawings.

### BRIEF DESCRIPTION OF THE DRAWINGS

FIG. 1 is a schematic view of a conventional side-type backlight module.

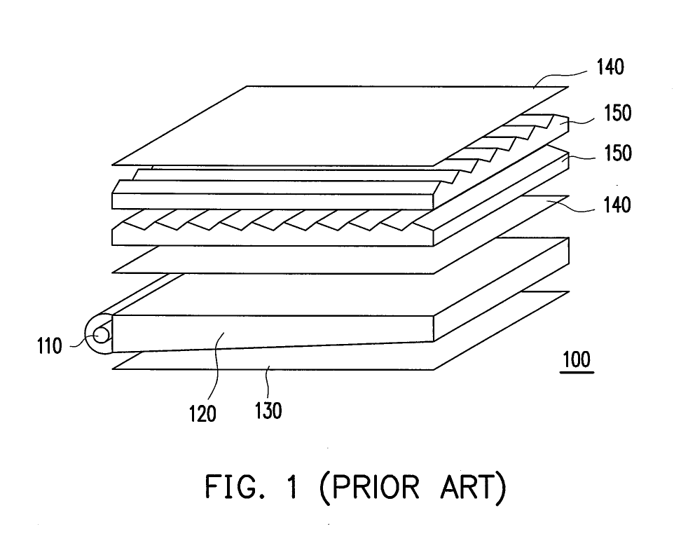

FIG. 2 is a perspective view of a light guide plate according to an embodiment of the present invention.

FIG. 3 is a graph of relations between brightness and viewing angles of light guide plates formed respectively with a single material structure and a bi-layered structure, which are obtained from computer simulation.

FIG. 4 is a schematic view of a light-reflecting structure.

FIG. 5 is a perspective view of a light guide plate according to another embodiment of the present invention.

### DESCRIPTION OF THE EMBODIMENTS

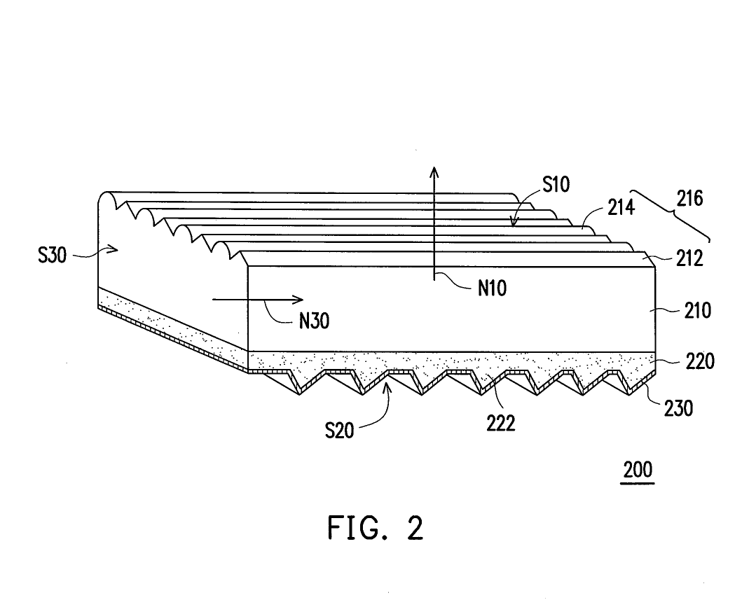

FIG. 2 is a perspective view of a light guide plate according to an embodiment of the present invention. Referring to FIG. 2, the light guide plate 200 has a light emitting surface S10, a bottom surface S20 and at least one light incident surface S30 connected with the light emitting surface S10 and the bottom surface S20. The light guide plate 200 is formed with a plurality of laminated material layers (two material layers 210 and 220 shown in this embodiment). Each of the material layers 210, 220 is substantially parallel to the light emitting surface S10. That is, the portion of the light guide plate 200 adjacent to the light emitting surface S10 is formed with one material (e.g., the material layer 210), and the portion of the light guide plate 200 adjacent to the bottom surface S20 is formed with another material (e.g., the material layer 220).

Generally, the light emitting surface S10 and the bottom surface S20 of the light guide plate 200 both have stripe-shaped micro-structures, and two sets of the micro-structures are generally perpendicular to each other. Wherein, more than two kinds of micro-structures having different shapes are formed on the light emitting surface S10, for example, a plurality of stripe-shaped light-controlling structures 216, to limit light emitting angle and to realize uniform illumination, and to prevent the light guide plate 200 from scratching with other elements. A plurality of light-reflecting structures 222 are formed on the bottom surface S20, which deflect the light to out-couple from light guide plate as well as control light emitting angle.

In this embodiment, the plurality of stripe-shaped light-controlling structures 216 can be a plurality of stripe-shaped light-converging structures 212 and a plurality of stripe-shaped light-diffusing structures 214 which are alternately arranged.

Wherein, when light entering through the light incident surface S30 is emitted through the light emitting surface S10, the stripe-shaped light-converging structures 212 cause light to be emitted in a direction more parallel to a normal line N10 of the light emitting surface S10. Additionally, the stripe-shaped light-diffusing structures 214 can diffuse the light passing therethrough. Therefore, when the light guide plate 200 is utilized in a backlight module or a light source device, light intensity in the normal viewing direction can be elevated without additional prism sheets and a uniform planar light source can be provided without additional diffusion sheets. Thereby, the overall cost of the backlight module or the light source device utilizing the light guide plate 200 can be greatly reduced. Moreover, because tops of the stripe-shaped light-diffusing structures 214 are more planar than those of the stripe-shaped light-converging structures 212, if the tops of the stripe-shaped light-diffusing structures 214 are formed higher than those of the stripe-shaped light-converging structures 212, the tops of the stripe-shaped light-converging structure 212 can be prevented from damages due to scratching with other elements. Furthermore, the ratio of the numbers of the stripe-shaped light-diffusing structures 214 and the stripe-shaped light-converging structures 212 are not limited to 1:1, which can be correspondingly varied depending on design requirements.

In FIG. 2, dimensions and scales of parts of the light guide plate 200 are adjusted for purpose of charity. Actual dimensions and scales can be adjusted depending on design requirements. Furthermore, while the light guide plate 200 is planar shape in this embodiment, the light guide plate 200 can be also wedge or other suitable shapes. Moreover, though the light guide plate 200 is described as single-side-incident type by way of example, it also can be dual-side-incident or multi-side-incident type.

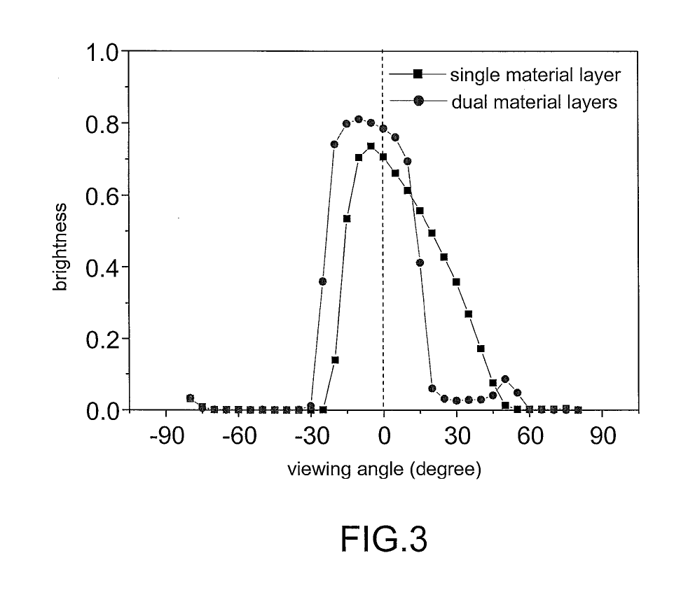

With respect to refractive indexes of the material layers 210 and 220, for example, the refractive indexes of the material layers 210 and 220 can be different from each other, and the difference between the maximal and minimal refractive indexes of the material layers 210 and 220 is not less than 0.03. If more material layers are utilized, the material layer can also be selected according this rule. In this embodiment, the refractive index of the material layer 210 is less than that of the material layer 220. When light entering through the light incident surface S30 passes through an interface between the material layer 210 and the material layer 220, the light incident on light-reflecting structures 222 can be more convergent due to the refraction. Therefore, when the light is reflected by the light-reflecting structures 222 and emitted through the light emitting surface S10, the light can be converged and emitted in a direction more parallel to the normal line N10 of the light emitting surface S10. FIG. 3 is a graph, obtained from computer simulation, of relations between brightness and viewing angles of a light guide plate formed with a single material structure and a bi-layered light guide plate 200 formed with two material layers 210 and 220. It can be found in FIG. 3, at normal viewing angle (i.e., viewing angle is 0 degree), the brightness of the bi-layered light guide plate 200 formed is about 10 percent higher than that of the light guide plate formed with a single material layer.

Referring to FIG. 2, in this embodiment, the stripe-shaped light-converging structures 212 are triangular prisms, and the stripe-shaped light-diffusing structures 214 are cylindrical convex lenses. Wherein, for example, apex angles of the stripe-shaped light-converging structures 212 are in a range of 80 to 120 degrees. Furthermore, cross-sections of the stripe-shaped light-converging structure 212 in this embodiment are isosceles triangles, but the cross-sections of the stripe-shaped light-converging structures 212 may not be isosceles triangles. The cross-sections of stripe-shaped light-converging structure 212 can be the same with or different from each other. Moreover, the cross-sections of the stripe-shaped light-diffusing structures 214 can be semi-cycles, semi-ellipses or other semi-arcs, and the cross-sections of the light-diffusing structure 214 can be the same with or different from each other.

Additionally, in another embodiment, the stripe-shaped light-converging structures 212 and the stripe-shaped light-diffusing structures 214 can both be triangular prisms, but the apex angles of the stripe-shaped light-converging structures 212 are in the range of 80 to 120 degrees to converge light, and the apex angles of the stripe-shaped light-diffusing structures 214 are in a range of 120 to 150 degrees to diffuse light. Furthermore, the apex angles of the stripe-shaped light-converging structure 212 are different from those of the stripe-shaped light-diffusing structures 214.

Please referring to FIG. 2, in this embodiment, light enters the light incident surface S30 in the direction substantially parallel to the normal line N30 of the light incident surface S30, and long axes of the stripe-shaped light-converging structures 212 and the stripe-shaped light-diffusing structures 214 are substantially parallel to the normal line N30 of the light incident surface S30.

Additionally, the light guide plate 200 further includes a reflecting layer 230 which cover entirely the bottom surface S20 and the light-reflecting structures 222. The reflecting layer 230 can be made of aluminium, sliver, nickel, alloy, or other suitable light reflecting materials.

Please still referring to FIG. 2, with respect to fabrication of the light guide plate 200, the stripe-shaped light-converging structures 212 and the stripe-shaped light-diffusing structures 214 can be formed on the material layer 210 by stamping process, injection molding or other processes. Furthermore, the material layer 220, made from ultraviolet curable resin, thermal curing glue, or other suitable material, is disposed in a die (not shown), and the material layer 210 is disposed on the material 220. Thereafter, the material layer 220 is cured and parted from the die, and the light-reflecting structures 222 are formed through the die. Alternatively, the material layer 210 and the material layer 220 can be formed separately and then adhered together. Wherein, adhering manners can be, for example, roll to roll to improve yield. The reflecting layer 230 can be formed after the light-reflecting structures 222 have been formed by sputtering, thermal evaporation, electric plating, or other suitable means, for example.

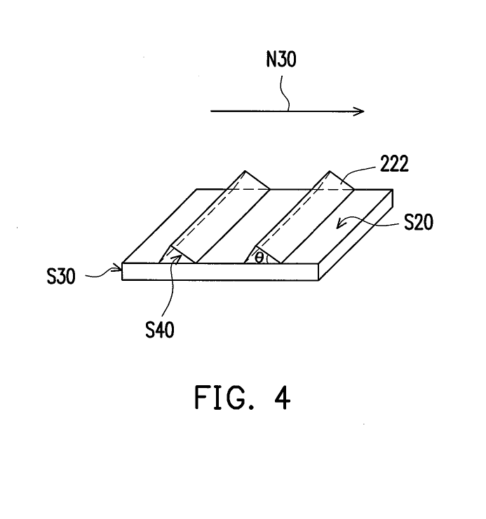

FIG. 4 is a schematic view of the light-reflecting structures. Referring to FIG. 4, since the light-reflecting structures 222 are formed on the bottom surface S20 of the light guide plate 200 shown in FIG. 2, the light-reflecting structures 222 are illustrated as pointing upward herein for purpose of clarity. In FIG. 4, the light-reflecting structures 222 are strip-shaped, and long axes of the light-reflecting structures 222 are substantially perpendicular to a normal line of the light incident surface (i.e., direction N30 shown in FIG. 4). Wherein, each of the light-reflecting structures 222 has a main reflecting surface S40, an angle θ between the main reflecting surface S40 and the bottom surface S20 is in a range of 25 to 40 degrees. Since other surfaces of the light-reflecting structures have little influence to light emitting, and will not be specially limited herein. Additionally, the main reflecting surface S40 of this embodiment is a single flat surface, but the main reflecting surface S40 can also be a single curved surface, or be combinations of a plurality of flat surfaces or a plurality of curved surfaces, even be combinations of at least one flat surface and at least one curved surface. Additionally, heights of the light-reflecting structures 222 can increase in the direction away from the light incident surfaces S30. Furthermore, distances between the adjacent light-reflecting structures 222 can decrease in the direction away from the light incident surfaces S30. Therefore, a smaller effective reflective light emitting area can be provided adjacent the light incident surface S30, and a larger effective reflective light emitting area can be provided away from the light incident surface S30 to compensate intensity loss of light during transmission, thence a uniform planar light source can be provided.

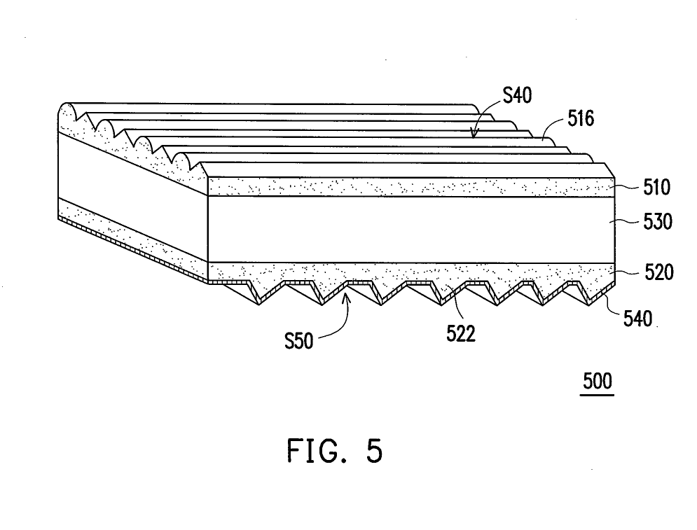

FIG. 5 is a perspective view of a light guide plate according to another embodiment of the present invention. Referring to FIG. 5, the light guide plate 500 of this embodiment is similar to the light guide plate 200 shown in FIG. 2, excepting that the light guide plate 500 is formed with three material layers 510, 520 and 530. A light emitting surface S40 is on the material layer 510, and a bottom surface S50 is on the material layer 520. The light emitting surface S40 and the bottom surface S50 are similar to the light emitting surface S10 and the bottom surface S20 shown in FIG. 2, respectively, having stripe-shaped light-controlling structures 516 and light-reflecting structures 522 similar to the stripe-shaped light-controlling structures 216 and the light-reflecting structures 222, respectively. Wherein, refractive indexes of the material layers 510 and 520 are larger than that of the material layer 530. The manufacture method of the material layers 510 and 520 is similar to that of the material layer 220 shown in FIG. 2. Additionally, the light guide plate 500 may further include a reflecting layer 540, which is disposed on and entirely covers the bottom surface S50 and the light-reflecting structures 522.

As mentioned above, because the light guide plate according to this invention is formed with a plurality of material layers, the angle of light incident to light-reflecting structures can be restricted, thence the convergency of emitted light is increased. At the same time, the travel direction of light can be controlled efficiently by the light-controlling structures of the light emitting surface and the light-reflecting structures of the bottom surface, to limit light emitting angle and uniform illumination. When the light guide plate of the invention is utilized in a backlight module or a light source device, no additional prism sheets are required, thus the overall cost of the backlight module or the light source device is reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A light guide plate, having a light emitting surface, a bottom surface and at least one light incident surface connected with the light emitting surface and the bottom surface, wherein the light guide plate is a superposition of a plurality of layers substantially parallel to the light emitting surface, the light emitting surface has a plurality of stripe-shaped light-controlling structures thereon, and the bottom surface has a plurality of light-reflecting structures thereon.

2. The light guide plate according to claim 1, wherein at least two of the plurality of layers are transparent materials with different refractive indexes, and difference between a maximal and a minimal refractive indexes of the plurality of layers is equal to or larger than 0.03.

3. The light guide plate according to claim 1, wherein the light emitting surface is on a first layer, and the bottom surface is on a second layer, wherein a refractive index of the first layer is less than that of the second layer.

4. The light guide plate according to claim 1, wherein the light emitting surface is on a first layer, the bottom surface is on a second layer, and a third layer is further disposed between the first and the second layers, and refractive indexes of the first and the second layer are larger than that of the third layer.

5. The light guide plate according to claim 1, wherein the stripe-shaped light-controlling structures comprise a plurality of stripe-shaped light-converging structures and a plurality of stripe-shaped light-diffusing structures arranged alternately.

6. The light guide plate according to claim 5, wherein the stripe-shaped light-converging structures are triangular prisms, and the stripe-shaped light-diffusing structures are cylindrical convex lenses.

7. The light guide plate according to claim 6, wherein apex angles of the stripe-shaped light-converging structures are in a range of 80 to 120 degrees.

8. The light guide plate according to claim 5, wherein the stripe-shaped light-converging structures are triangular prisms with apex angles in a range of 80 to 120 degrees, and the stripe-shaped light-diffusing structures are triangular prisms with apex angles in a range of 120 to 150 degrees.

9. The light guide plate according to claim 8, wherein apex angles of the stripe-shaped light-converging structures are different from those of the stripe-shaped light-diffusing structures.

10. The light guide plate according to claim 1, wherein long axes of the stripe-shaped light-controlling structures are substantially parallel to a normal line of the light incident surface.

11. The light guide plate according to claim 1, wherein the light-reflecting structures are strip-shaped, long axes of the light-reflecting structures are substantially perpendicular to a normal line of the light incident surface.

12. The light guide plate according to claim 1, wherein each of the light-reflecting structures has a main reflecting surface, an angle between the main reflecting surface and the bottom surface is in a range of 25 to 40 degrees.

13. The light guide plate according to claim 12, wherein the main reflecting surfaces are single flat surfaces, single curved surfaces, a plurality of flat surfaces, a plurality of curved surfaces or combinations of at least one flat surface and at least one curved surface.

14. The light guide plate according to claim 1, wherein heights of the light-reflecting structures increase in a direction away from the light incident surface.

15. The light guide plate according to claim 1, wherein the distances between the light-reflecting structures decrease in a direction away from the light incident surface.

16. The light guide plate according to claim 1, further comprising a reflecting layer which is disposed on and entirely covers the bottom surface and the light-reflecting structures.
